(19) United States
(12) Patent Application Publication
(10) Pub. No.: US 2025/0159601 A1
(43) Pub. Date: May 15, 2025

(54) SELECTING ACCESS POINTS FOR SERVING A USER EQUIPMENT

(71) Applicant: Telefonaktiebolaget LM Ericsson (publ), Stockholm (SE)

(72) Inventors: Joao VIEIRA, Hjärup (SE); Pål FRENGER, Linköping (SE); Erik G. LARSSON, Linköping (SE); Andres REIAL, Lomma (SE)

(21) Appl. No.: 18/715,421

(22) PCT Filed: Dec. 3, 2021
(86) PCT No.: PCT/EP2021/084293

§ 371 Date: May 31, 2024

(51) Int. Cl. H04W 48/20; H04W 48/16

(52) U.S. Cl. CPC H04W 48/20; H04W 48/16

(57) ABSTRACT

A method of selecting access points for serving a User Equipment (UE). The method includes receiving, for each access point in a first set of one or more access points, information identifying channel information between the access point and the UE, wherein the first set of access points includes access points currently serving the UE, receiving, for each access point in a second set of one or more access points, information identifying channel information between the access point and the UE, wherein the second set of access points have points not currently serving the UE, and selecting one or more access points from the first set of one or more access points and/or one or more access points from the second set of one or more access points to serve the UE based on the information identifying the channel information between the UE and the access points.

### TECHNICAL FIELD

Examples of the present disclosure relate to selecting access points for serving a User Equipment (UE).

### BACKGROUND

The project leading to this application has received funding from the European Union's Horizon 2020 research and innovation programme under grant agreement No 101013425.

Distributed multiple-input multiple-output (D-MIMO, also known as “cell-free massive MIMO”, Radio Stripes, or RadioWeaves) is a key technology candidate for the 3rd Generation Partnership Project (3GPP) 6th generation (6G) physical layer. The basic principle behind D-MIMO is to distribute service antennas geographically and have them operate phase-coherently together. In an example D-MIMO architecture, multiple antenna panels (also referred to as access points or APs) are interconnected and configured in such a way that more than one panel can cooperate in coherent decoding of data from a given UE, and more than one panel can cooperate in coherent transmission of data to a UE. Each antenna panel in turn may comprise multiple antenna elements that are configured to operate phase-coherently together. Example implementations may use time-division duplexing (TDD), relying on reciprocity of the propagation channel, whereby uplink pilots transmitted by the UEs are used to estimate both the uplink and downlink channel responses. This type of TDD operation may be referred to as reciprocity-based operation.

To make deployment of a large number of distributed MIMO access points simple and cost efficient, various solutions have been proposed, such as Radio Stripes and RadioWeaves. A common feature is to use a shared fronthaul together with a high degree of integration and miniaturization. An electronic circuit containing the digital signal processor (DSP), antenna panel, and external interfaces (for power supply and data) is called an antenna processing unit, or APU. In this document these will be referred to as access points (APs). An example of an APU or AP 100 is shown in FIG. 1. The AP 100 includes an antenna panel 102 that comprises four antenna elements 104. The AP 100 also includes four external interfaces 106. The external interfaces in the example AP 100 are located at the edges of the AP 100 such that they may communicate with one or more adjacent APs.

Multiple APs, such as the AP 100, may be connected directly or via one or more other APs to a processing node, also referred to herein as a central processing unit (CPU). In one example network 200, shown in FIG. 2, that uses an arrangement referred to as RadioWeaves, APs 202 may be connected to between one and four adjacent APs 202, and at least one of the APs 202 is connected to a CPU 204. Thus, each of the APs 202 may communicate with the CPU 204. In another example network 300, shown in FIG. 3, which uses an arrangement referred to as Radio Stripes, APs are arranged in multiple series arrangements, referred to as stripes 302, such that each stripe 302 includes multiple APs 304. Within a stripe 302, each AP 304 is connected to the two adjacent APs, with the exception of an AP 304 that is furthest from the CPU 306, which AP 304 is connected only to one adjacent AP 304. Another exception is the AP 304 closest to the CPU 306, which is connected to the CPU 306 and one adjacent AP 304. Thus each AP 304 in the stripes 302 can communicate with the CPU 306.

Processing, e.g. uplink reception, can be done in many ways in a D-MIMO system. An overview is presented in Emil Björnson and Luca Sanguinetti, “Making Cell-Free Massive MIMO Competitive With MMSE Processing and Centralized Implementation,” IEEE Transactions on Wireless Communications, vol. 19, no. 1, pp. 77-90, January 2020.

The ideal theoretical approach to support multi-stream uplink and downlink transmissions is one in which precoders and decoders in an AP network are constructed based on the aggregated channel response. That is, the precoder or decoder used in one AP depends on uplink or downlink channel responses of other APs. However, this requires all APs to be active and decode (on uplink) and transmit (on downlink) in a joint fashion in order to ensure coherent operation, which is very challenging. This also means that the system (or network) needs to be designed to support a high baseband processing computational load, due to the large sizes of the aggregate channel response matrices. In addition, the fronthaul that interconnects the APs needs to accommodate high loads of data traffic between APs. There is thus a need for an AP selection mechanism that limits AP cooperation to a small subset of nodes where the subset can be adapted flexibly based on varying channel conditions, while maintaining good performance.

### SUMMARY

Examples of this disclosure may provide the advantages of reduced fronthaul load and reduced computational complexity. This may also provide reduced energy consumption in a network and simpler network configurations.

One aspect of the present disclosure provides a method in a node in a network of selecting access points for serving a User Equipment (UE). The method comprises receiving, for each access point in a first set of one or more access points, information identifying channel information between the access point and the UE, wherein the first set of access points comprises access points currently serving the UE, and receiving, for each access point in a second set of one or more access points, information identifying channel information between the access point and the UE, wherein the second set of access points comprise access points not currently serving the UE. The method also comprises selecting one or more access points from the first set of one or more access points and/or one or more access points from the second set of one or more access points to serve the UE based on the information identifying the channel information between the UE and the access points in the first and second sets of access points.

Another aspect of the present disclosure provides apparatus in a node in a network of selecting access points for serving a User Equipment (UE). The apparatus comprises a processor and a memory. The memory contains instructions executable by the processor such that the apparatus is operable to receive, for each access point in a first set of one or more access points, information identifying channel information between the access point and the UE, wherein the first set of access points comprises access points currently serving the UE, receive, for each access point in a second set of one or more access points, information identifying channel information between the access point and the UE, wherein the second set of access points comprise access points not currently serving the UE, and select one or more access points from the first set of one or more access points and/or one or more access points from the second set of one or more access points to serve the UE based on the information identifying the channel information between the UE and the access points in the first and second sets of access points.

An additional aspect of the present disclosure provides apparatus in a node in a network of selecting access points for serving a User Equipment (UE). The apparatus is configured to receive, for each access point in a first set of one or more access points, information identifying channel information between the access point and the UE, wherein the first set of access points comprises access points currently serving the UE, receive, for each access point in a second set of one or more access points, information identifying channel information between the access point and the UE, wherein the second set of access points comprise access points not currently serving the UE, and select one or more access points from the first set of one or more access points and/or one or more access points from the second set of one or more access points to serve the UE based on the information identifying the channel information between the UE and the access points in the first and second sets of access points.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of an antenna processing unit (APU) or access point (AP);

FIG. 2 shows an example of a network:

FIG. 3 shows another example of a network:

FIG. 4 shows an example of a network according to examples of this disclosure;

FIG. 5 is a flow chart of an example of a method in a node in a network of selecting access points for serving a User Equipment (UE);

FIG. 6 shows another example of a network according to examples of this disclosure:

FIG. 7 is a schematic of an example of an apparatus in a node in a network for selecting access points for serving a User Equipment (UE);

FIG. 8 schematically illustrates a telecommunication network connected via an intermediate network to a host computer:

FIG. 9 is a generalized block diagram of a host computer communicating via a base station with a user equipment over a partially wireless connection; and

FIGS. 10 to 13 are flowcharts illustrating methods implemented in a communication system including a host computer, a base station (or access point) and a user equipment.

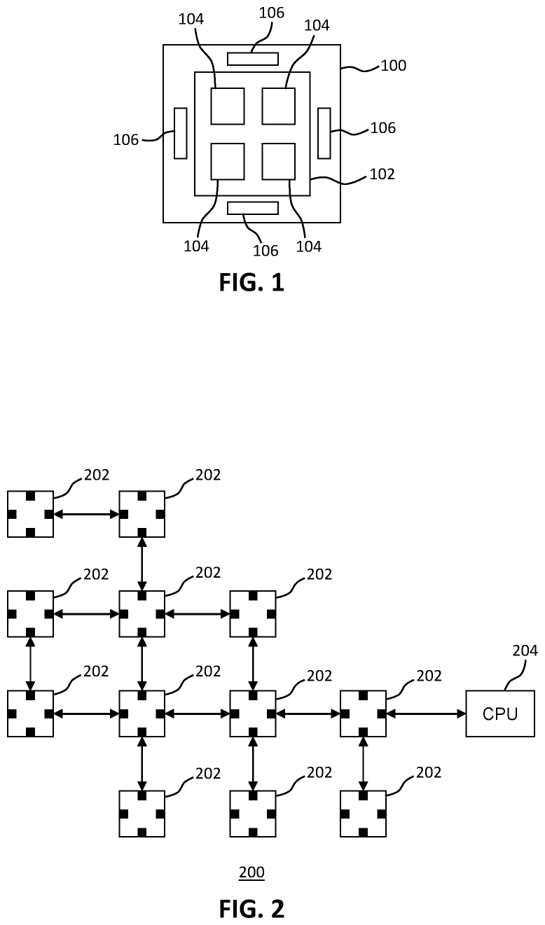

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

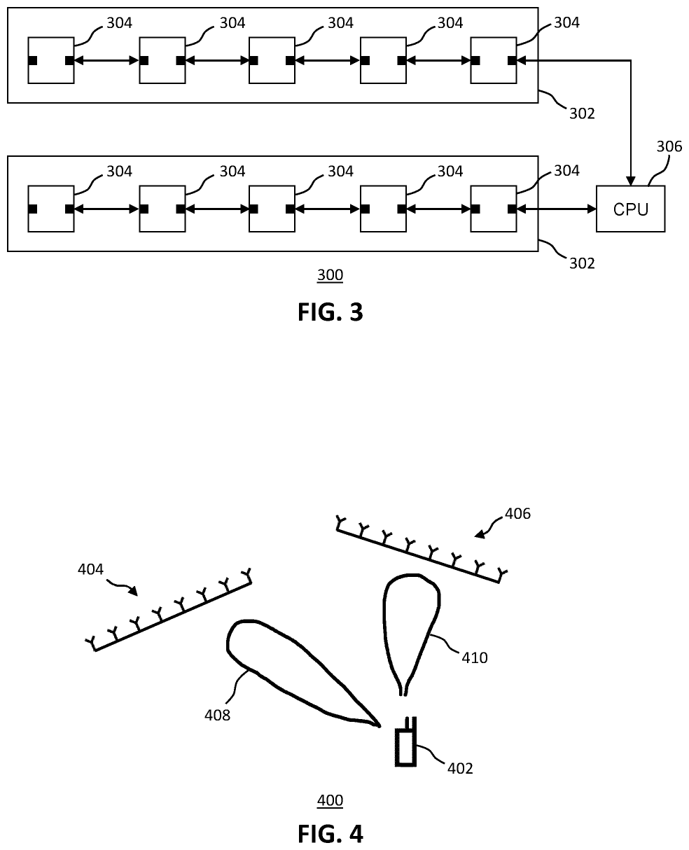

In examples of this disclosure a D-MIMO system is considered with L APs, each equipped with M antennas, serving a User Equipment (UE) with N antennas. The APs are interconnected with one another such that each AP may communicate with a central processor such as a Central Processing Unit (CPU), for example in a Radio Stripes or RadioWeaves topology as shown in FIG. 2 or 3. To model the physical propagation channel, the time-frequency plane is partitioned into coherence blocks (e.g., the physical resource blocks (PRBs) in an Orthogonal Frequency Division Multiplexing (OFDM) system), during which the channel is considered to be static. Let Gₗ be an M×N-matrix that contains the uplink channel responses between the UE and AP l, in a given coherence block. Specifically, the (m, n)th element of Gt contains the channel from the nth UE antenna to the mth antenna of AP l.

Since the UE may have multiple antennas, in some examples, it can multiplex several streams (both on uplink and on downlink). Fundamentally, this ability to multiplex several streams depends on the properties of the propagation channel between the UE and all APs serving that UE. Mathematically, for example, for the uplink, the rank of the aggregate channel comprising all M×N channel responses for all L APs, [G₁, . . . , G_{L}], determines the number of streams that can be multiplexed, and it is very likely in some examples that this aggregate channel has rank greater than one. Provided that the UE has enough antennas, the rank of the aggregate channel may be at least equal to the number of APs that are near the UE (each AP thus supporting at least one data steam).

As indicated above, a precoder/decoder in a network can be designed based on the aggregated channel response [G₁, . . . , G_{L}]. However, this requires all APs to be active and decode (on uplink) and transmit (on downlink) in a joint fashion in order to ensure coherent operation which is very challenging in practice.

Examples of this disclosure may provide a network that is implemented as a D-MIMO system with a central processor (e.g. CPU), at least one UE and at least two APs. Each AP is assigned at least one of the functions “serving” (S) and “observing” (O) for a particular UE. The UE may periodically transmit an uplink pilot. APs designated as O periodically estimate the channels to the UE and report channel information on these channels to a node such as a central processor. The central processor (or other node), with a pre-determined periodicity, may for example apply a pre-determined mapping to the channels estimates, and based on this mapping, may reassign the functionality S and O to each AP.

APs designated as S for a UE may for example periodically obtain channel information for channels between the AP and the UE. Based on the channel information, the APs may determine precoders that are communicated to the UE. The UE may then transmit data using these precoders, and the data streams may be decoded at the APs assigned the function S for the UE. In some examples, one or more APs in a network may be designated as serving(S) for one or more particular UEs, and observing (O) for one or more other UEs.

As indicated above, examples of this disclosure may provide the advantages of reduced fronthaul load and reduced computational complexity. This may also provide reduced energy consumption in a network and simpler network configurations.

Examples of this disclosure may include a set of network procedures that may for example be executed once per UE that the network serves, and may in some examples be executed periodically. Examples of this disclosure are described in the context of one UE, though in other examples where there are multiple UEs, multiple instances of examples of this disclosure may be executed, for example in parallel.

In some examples, a network includes available APs that can potentially serve a given UE. Such set of APs is partitioned into two sets, namely, a set of serving(S) APs, and a set of observing (O) APs. This partitioning may be performed on a particular time scale or periodicity, such as for example a slow time scale. Examples of such a time scale include every 10 New Radio (NR) frames, every second, or whenever large-scale fading parameters have significantly changed. The partitioning time scale may also be based on the rate of arrival or removal of UEs to be scheduled. The serving APs participate actively in the data transmission to/from the UE, while the observing APs measure or monitor channel responses and forward these responses, or channel information based on these responses, to the node such as the central processor. In some examples, the cardinality of the set of serving APs is the same as the number of data streams that is to be received from the UE (e.g. two). This type of network configuration may allow the required or desired number of data streams, while keeping the number of serving APs to a minimum. In some examples, the selection of the serving APs is done based on long-term channel properties that are collected from the serving APs and observing APs. In other examples, the selection may be done based on short-term channel properties. Examples of this disclosure provide different types of selection criteria that may guarantee that favorable propagation conditions exist on average, and thus may allow for each serving AP to detect one data stream from a UE with low interference from other data streams from the UE.

Other example aspects of this disclosure may be carried out within a time scale much smaller than that of the selection of serving and observing APs for a UE, e.g. every coherence block (e.g. within a time equal to or shorter than a coherence time of a channel) or every NR slot. In such examples, the UE sends pilot signals or reference signals for the purpose of uplink channel estimation. The serving APs estimate the channel, determine their decoding and precoding vectors, and inform the UE of its precoding vectors. The UE may then transmit data using the precoding vectors, which is decoded by the serving APs.

Optionally the observing APs estimate the channels or determine some information regarding the channels. This may for example be done with a certain periodicity (e.g. every Tth coherence block), or according to a pre-determined pattern. It can also be done adaptively.

FIG. 4 shows an example of a network 400 in which a UE 402 is served by two multi-antenna APs 404 and 406. In the example shown, the UE 402 has two antennas (N=2) the UE 402 may perform uplink beamforming of a first stream 408 to AP 404 and a second stream 410 to AP 406. Similarly, though not shown in FIG. 4, in some examples on downlink the UE 402 may receive a first stream from AP 404 and a second stream from AP 406.

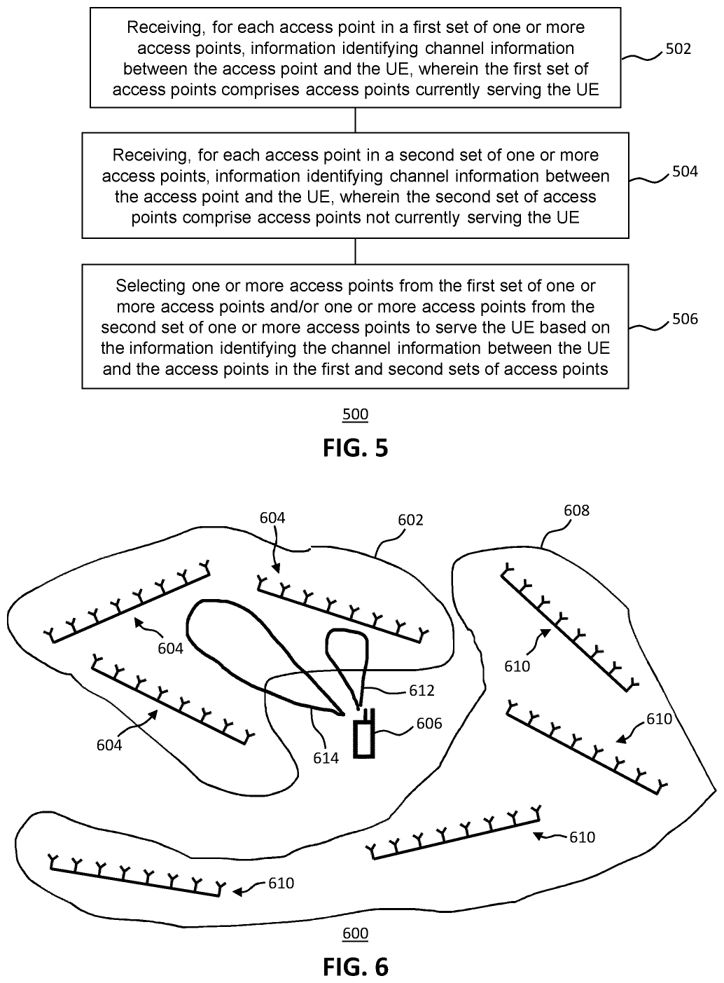

FIG. 5 is a flow chart of an example of a method 500 in a node in a network of selecting access points for serving a User Equipment (UE). The node in the network may be for example a central processor, CPU, access point (AP), or any other suitable node. The method comprises, in step 502, receiving, for each access point in a first set of one or more access points, information identifying channel information between the access point and the UE, wherein the first set of access points comprises access points currently serving the UE. The channel information could be for example channel state information or channel estimates. In some examples, the first set of access points comprises those access points designated as “S” (serving) access points as indicated above.

Step 504 of the method 500 comprises receiving, for each access point in a second set of one or more access points, information identifying channel information between the access point and the UE, wherein the second set of access points comprise access points not currently serving the UE. The channel information may be for example channel state information or channel estimates, or any other information that indicates some property of the channel. In some examples, the second set of access points comprises those access points designated as “O” (observing) access points as indicated above.

The information identifying the channel information between each access point of the first and/or second sets of one or more access points and the UE may in some examples comprise information identifying respective channel information between each antenna of the access point and each antenna of the UE. For example, the information identifying the channel information between the UE and each access point in the first set of one or more access points may be information identifying channel estimates of channels between the UE and each access point in the first set of one or more access points. Additionally or alternatively, in some examples, the information identifying the channel information between the UE and each access point in the second set of one or more access points comprises one or more of the following: information identifying channel estimates of channels between the UE and each access point in the second set of one or more access points, information identifying signal strength of a signal between the UE and each access point in the second set of one or more access points, or information identifying a path loss between the UE and each access point in the second set of one or more access points. In some examples, the information from the serving APs may be more detailed than that from the observing APs, for example to reduce fronthaul capacity usage and/or processing due to the information sent from the observing APs. In some examples, the information identifying the channel information between the UE and each access point in the first and second sets of one or more access points may be based on pilot signals (e.g. SRS) and/or data signals, including embedded reference signals, transmitted by the UE.

Step 506 of the method 500 comprises selecting one or more access points from the first set of one or more access points and/or one or more access points from the second set of one or more access points to serve the UE based on the information identifying the channel information between the UE and the access points in the first and second sets of access points. Thus, for example, the sets of serving and observing APs may be selected based on the channel information between the UE and every AP of both sets.

Two sets of APs are defined in some examples: a set of serving APs and a set of non-serving APs (also referred to herein as observing APs) for a particular UE. (There may also be other APs in the network, that are neither serving nor observing APs for a particular UE.) These sets may be disjoint sets in some examples, that is, no AP is common to both sets. The union of both sets is referred to herein as a super-set (which may or may not contain all APs in the network). The super-set may in some examples be determined as follows. The network may first measure a channel property (e.g. path gain or reference signal received power, RSRP, based on a reference signal such as sounding reference signal, SRS) between the UE in question and candidate APs of the network, which may or may not be all APs in the network. The set of APs for which the channel property satisfies a predetermined criterion (e.g. the estimated path gain is larger than a pre-defined threshold) is included in the super-set for the UE. In alternative examples, the UE may measure a reference signal, e.g. synchronization signal block, transmitted from multiple APs, and report related signal qualities (e.g. path gain/loss, RSRP etc) to the network. While examples of this disclosure are described in the context of uplink (UL) measurements by multiple APs, in other examples instead downlink (DL) measurements of reference signals of APs in the superset may be determined and reported back from the UE to the network.

From the super-set, a node such as a central processor or CPU may in some examples determine which APs should be serving APs and observing APs for the UE.

In some examples, the role of the serving APs is to participate in the transmission and reception of data to/from the UE. They may in some examples be active in every coherence block (although transmissions to/from a specific UE may not necessarily be scheduled for every coherence block in some examples) and perform decoding of data. Each serving AP may in some examples receive and decode one stream from the UE on uplink. In alternative examples, however, at least one stream may be received and decoded by more than one serving AP.

The observing APs in some examples may be considered as candidates to become serving APs or replace APs in the serving AP set. The observing APs may in some examples provide the node (e.g. central processor or CPU) with further information to support the selection of the APs that are in the serving AP set. For example, the observing APs may monitor reference signals sent during uplink data transmissions, or monitor explicitly triggered SRS transmissions.

FIG. 6 shows another example of a network 600. The network 600 includes a first set 602 of multi-antenna APs 604 that are serving APs for a UE 606, and a second set 608 of multi-antenna APs 610 that are non-serving APs (e.g. observing APs) for the UE 606. The sets 602 and 608 of APs together comprise a super-set of APs for the UE 606.

In some examples, the set of observing APs is comprised of the APs (other than serving APs) for which the long-term path loss to the UE is less than a predetermined threshold. In other examples, metrics other than path loss may be used, e.g. average SINR, estimated achievable data rate or mutual information in the presence of other transmissions, etc. The set of observing APs may be reselected periodically or when the path losses substantially change.

Referring back to the method 500 of FIG. 5, the method may in some examples include sending an indication to each of the selected one or more access points that the access point is to serve the UE. Thus the serving APs become aware that they are to serve the UE. The method 500 may also in some examples comprise sending, to each access point that is not selected in the first set of one or more access points, an indication that the access point is to not serve the UE. Thus for example those AP(s) may become observing APs (which may in some examples be indicated in the indication).

In some examples, selecting one or more access points from the first set of one or more access points and/or one or more access points from the second set of one or more access points to serve the UE in step 506 comprises reselecting the first set of access points based on the information identifying the channel information between the UE and the access points in the first and second sets of access points, and wherein the method comprises repeating the method 500 of selecting access points for serving the UE. Thus for example the sets of serving and observing access points for the UE may dynamically change over time depending on channel conditions.

The method 500 may in some examples comprise, for each of at least one further UE, receiving, for each access point in a respective third set of one or more access points, information identifying channel information between the access point and the further UE, wherein the respective third set of access points comprise access points currently serving the further UE, and receiving, for each access point in a respective fourth set of one or more access points, information identifying channel information between the access point and the further UE, wherein the respective fourth set of access points comprise access points not currently serving the further UE. Thus, for example, the method 500 may comprise selecting one or more access points from the respective third set of one or more access points and/or one or more access points from the respective fourth set of one or more access points to serve the further UE based on the information identifying the channel information between the UE and the access points in the respective third and fourth sets of access points. Hence, for example, the method 500 may effectively be performed independently for multiple UEs, where the serving and observing sets (and in some examples also the super-sets) may vary between the UEs.

The information identifying the channel information between each access point of the third and/or fourth sets of one or more access points and the further UE may comprise for example information identifying respective channel information between each antenna of the access point and the further UE. The method 500 may in some examples sending an indication to each of the selected one or more access points for each further UE that the access point is to serve the further UE, and may also comprise sending, to each access point that is not selected in the respective third set of one or more access points for each further UE, an indication that the access point is to not serve the further UE. The respective third and fourth sets of one or more access points for each further UE may in some examples comprise access points whereby, for each access point, a property of a channel between the access point and the further UE satisfies a predetermined criterion.

The step 506 of selecting one or more access points from the first set of one or more access points and/or one or more access points from the second set of one or more access points to serve the UE may in some examples comprises selecting up to a predetermined number of access points from the first set of one or more access points so as to maximize a rate of data (e.g. estimate data rate) transmitted between the UE and the selected one or more access points. The predetermined number may thus be in some examples a maximum number of APs that a UE is permitted to be served by in the network.

In other examples, the step 506 of selecting one or more access points from the first set of one or more access points and/or one or more access points from the second set of one or more access points to serve the UE may comprise selecting a number of access points from the first and/or second sets of access points with highest data rates (e.g. estimated data rates) determined based on the channel information between the access point and the UE. The selected number of access points may for example be greater than, or may be equal to, a number of data streams transmitted to and/or from the UE.

In other examples, the step 506 of selecting one or more access points from the first set of one or more access points and/or one or more access points from the second set of one or more access points to serve the UE comprises selecting a number of access points from the first and/or second set of access points with a smallest inner product of channel vectors, wherein the channel vectors are determined based on the channel information between the access points and the UE. The selected number of access points may for example be greater than, or may be equal to, a number of data streams transmitted to and/or from the UE.

In some examples, the section of access points to be serving and/or observing APs for a UE may be performed based on the availability of fronthaul capacity. For example, the step 506 of selecting one or more access points from the first set of one or more access points and/or one or more access points from the second set of one or more access points to serve the UE may in some examples comprise selecting one or more access points with available fronthaul capacity for exchanging user data between the one or more access points and a processing node. For example, APs may be selected to be serving and/or observing where there is available fronthaul capacity to send channel information from the AP to a node such as a central processor or CPU.

The method 500 may in some examples comprise receiving the information identifying the channel information between the first set of one or more access points and the UE with a periodicity equal to or longer than a coherence time of a channel between the first set of one or more access points and the UE. In addition, in some examples, the method 500 may comprise receiving the information identifying the channel information between the second set of one or more access points and the UE with a periodicity longer than the periodicity of receiving the information identifying the channel information between the first set of one or more access points and the UE. This may for example reduce the fronthaul capacity used by sending channel information from the observing APs compared to the serving APs.

In some examples, the method 500 may comprise selecting the one or more access points from the first set of one or more access points and/or one or more access points from the second set of one or more access points to serve the UE with a periodicity equal to or longer than a periodicity of a coherence block, or equal to or longer than the coherence time of a channel between the AP(s) and the UE.

In particular examples of this disclosure, two processes are executed in parallel. A first process is the selection or reselection of serving and observing APs for each UE in or communicating with the network.

This process may be executed, in some examples, at a lower periodicity than the second process. In the first process, in some examples, the (current) serving and observing APs estimate the channel to the UE, and communicate channel information (e.g. channel estimates) to the CPU. In some examples, channel estimates are communicated to the CPU with a pre-determined periodicity typically larger than each coherence block/coherence time of the channel (e.g. every 10 NR frames or every second). In alternative examples, channel information may be communicated to the CPU for every coherence block.

Next, based on the channel information, the CPU may select that APs that are to be serving and observing APs for the UE. In some examples, the AP selection is performed with a pre-determined periodicity, such as for example in every coherence block. The CPU may then inform each APs about their role as serving or observing APs as appropriate.

In examples of a second process, that may be performed for example in every coherence block, the UE transmits pilots through its N antennas. These pilots are received at the serving APs. The N pilot waveforms sent by the N UE antennas may in some examples be mutually orthogonal. For example, pilots transmitted by different antennas can be defined by time-samples that lie at different points in the time-frequency grid (different OFDM symbols/subcarriers). In other examples, the pilot waveforms may be precoded using a set of beamformers, such that a first pilot waveform is beamformed in a first direction, a second pilot waveform is beamformed in a second direction, and so on. These directions may be predetermined or obtained by the UE based on long-term channel statistics, or based on control messages received from the network (e.g. from the central processor or CPU). The pilot signals (e.g. those referred to above with reference to the method 500 of FIG. 5) may in some examples be sounding reference signals (SRSs), where the UE may assign a distinct precoder to each SRS transmission. Such SRS transmission occasions may for example be configured periodically, or triggered by the network via a downlink control channel while the choice of SRS beamformers for the multiple transmissions may be selected by the UE. Alternatively, for example, the pilot signals may also be demodulation reference signals (DMRSs) where different DMRSs are associated with distinct precoders. The precoder setting may be inherited from DMRS configurations.

Next, each serving AP, such as AP l, obtains a channel estimate Ĝₗ (of dimension M×N) by processing the measured uplink channels through any suitable method known in the art, for example least-squares or minimum mean square error (MMSE). Henceforth. Gₗ is used to represent the channel obtained at AP l. The uplink pilots sent by the UE are also received at the observing APs. In some examples, all observing APs receive pilots in every coherence block. In other examples, however, the observing APs receive UE pilots according to a pre-determined pattern, for example with a pre-determined periodicity (which in some examples is lower than the periodicity of a coherence block or the coherence time of the channel). An observing AP that receives pilots also determines channel information such as a channel estimate. Serving APs, and optionally observing APs, reports their channel estimates to the CPU.

In every coherence block, the serving APs may also determine beamforming vectors to be used by the serving APs themselves for reception, and by the UE for transmission. These beamforming vectors may be determined for example based on the channel information determined earlier. Examples of how these beamformers can be determined are provided below. These are described for single-stream and dual-stream operation, in which case two serving APs are involved, but the examples may also be extended more generally to multi-stream operation (e.g, with three or more streams and APs).

As a first example, the UE may be configured to transmit a single stream, shown as stream or beam 612 in FIG. 6, that is received at one of the serving APs, such as an AP/604 in the first set 602 of serving APs. The signal received at AP l is yₗ=\sqrt{P}Gₗas+Wₗ, where P is the UE transmit power, a is the N×1 unit-norm beamformer applied by the UE, s is the transmitted symbol, and wₗ is noise.

All noise terms are assumed to be statistically white with unit variance per component, and zero mean. AP l applies a beamformer, for example maximum-ratio combining, to obtain an estimate of s. Maximum-ratio beamforming entails, specifically, the application of a receive beamforming vector equal to the conjugate transpose of Gₗa, that is, (Gₗa)^{H}. This yields the (soft) symbol estimate ŝ=a^{H}Gₗ^{H}Gₗas+a^{H}Gₗ^{H}wₗ. The SNR in ŝ is a^{H}Gₗ^{H}Gₗa. Consequently, the choice of transmit beamformer at the UE, a, that maximizes the SNR is to take a equal to the dominant eigenvector of Gₗ^{H}Gₗ. The resulting SNR in s is Pλₘₐₓ(Gₗ^{H}Gₗ), and hence the single-stream rate is Rₛ=log₂(1+Pλₘₐₓ(Gₗ^{H}Gₗ)), where λₘₐₓ is the dominant eigenvalue of Gₗ^{H}Gₗ

In some examples, a, and P₁ are recomputed in every coherence block. In other examples, they are computed at a slower time-scale and/or for wide-band precoding, based on long-term statistics.

As a second example, the UE may be configured to transmit two streams, e.g, streams or beams 612 and 614 shown in FIG. 6, and different symbols (symbols s and s′) may be received by two different APs l and l′. Thereby, AP l detects s and AP l′ detects s′. The UE applies two different unit-norm beamformers a and b, with powers P₁ and P₂ such that P₁+P₂=P. The received signal at AP l is:

$${y}_{l} = \sqrt{{P}_{1}} {G}_{l} as + \sqrt{{P}_{2}} {G}_{l} {bs}^{′} + {w}_{l} .$$

AP l can decode s by applying a receive beamformer. For example, it can apply maximum-ratio combining. Alternatively, for example, it can apply a zero-forcing beamformer (Gₗ[a, b])⁺ where (⋅)⁺ is the pseudo-inverse (i.e., A⁺=(A^{H}A)⁻¹A^{H}) and [a, b] denotes the two vectors a and b concatenated side-by-side, which offers improved suppression of interference. The use of a zero-forcing beamformer specifically results in the soft symbol estimate:

$$s = {[ {( {G}_{l} [ a , b ] )}^{+} {y}_{l} ]}_{1} = \sqrt{{P}_{1}} s + {[ {( {G}_{l} [ a , b ] )}^{+} {w}_{l} ]}_{1}$$

where [.]ᵢ denotes the ith element of a vector. The so-obtained ŝ is interference-free and the variance of the noise in the second term is [((Gₗ[a, b])^{H}(Gₗ[a, b]))⁻¹]_{1,1}. The rate for the first stream therefore is:

$${R}_{1} = {log}_{2} ( 1 + \frac{{P}_{1}}{{[ {( {( {G}_{l} [ a , b ] )}^{H} ( {G}_{l} [ a , b ] ) )}^{- 1} ]}_{1 , 1}} )$$

where [.]_{i,j} denotes the (i, j)th element of a matrix. Similarly, the rate at AP l′ for the second stream is:

$${R}_{2} = {log}_{2} ( 1 + \frac{{P}_{2}}{{[ {( {( {G}_{{l}^{′}} [ a , b ] )}^{H} ( {G}_{{l}^{′}} [ a , b ] ) )}^{- 1} ]}_{2 , 2}} )$$

The total rate for both streams is R₁+R₂.

An optional extension to examples of this disclosure is to perform null-forming towards additional UEs. Specifically, for example, instead of (Gₗ[a, b])⁺, a zero-forcing beamformer (Gₗ[a, b, C])⁺ could be used where C is a matrix whose columns contain channel vectors associated with these additional UEs.

In some examples, a, b, P₁ and P₂ are recomputed in every coherence block. The beamformers a and b, and the corresponding powers P₁ and P₂ can then be found for example through a numerical search. Alternatively, for example, a simple heuristic (approximate) algorithm can be used by running a grid search over P₁, set P₂=P−P₁, and for each candidate P₁ take a to be the dominant eigenvector (normalized to unit norm) of Gₗ^{H}Gₗ and b to be the dominant eigenvector of G_{l′}^{H}G_{l′}. P₁ and P₂ can also be selected in some examples via a pre-determined function of the path losses to the UE, and then take a and b to be said dominant eigenvectors.

In alternative examples, a, b, P₁ and P₂ (or a subset of them) are selected based on estimated long-term statistics of the channels. In some examples, this selection is performed by the node (e.g, central processor or CPU) to offload processing from the APs. For example, the serving APs may report their channel estimates to the CPU according to a pre-determined schedule (e.g, periodically). Let Gₗ^{t} be the channel estimate associated with AP l at time t, reported to the CPU. The CPU then first determines a time window length, T, that will be used to define the long-term statistics. This window length, T, may either be pre-determined, or adaptively selected based on information on the time-variability of the channels. For example, in a static environment, T may be selected large and in a highly mobile environment it may be small. Given T, and for hypothetical P₁, P₂, a and b, the CPU computes a long-term rate consisting of a time average of R₁+R₂ obtained by inserting the channels {Gₗ^{t-T}, G_{l′}^{t-T}, Gₗ^{t-T+1}, G_{l′}^{t-T+1}, . . . , Gₗ^{t}, G_{l′}^{t}} into the above rate formulas. The CPU may then select a, b, P₁ and P₂ to maximize the so-obtained averaged (over t) R₁+R₂.

In the next step of the example of a second process referred to above, the UE beamformers (a for single-stream transmission: P₁, P₂, a and b for dual-stream transmission) obtained by the above procedure are signaled to the UE over a control channel. Known vector quantization techniques may be used in some examples, or alternatively a beamspace codebook may be used. For example, the network signals to the UE a codebook entry which is closest to the optimal UE beamformer. Closeness could for example be defined in terms of the largest normalized inner-product, which may in some examples be the same as the codebook entry with the smallest principal angle with respect to an optimal solution.

In other examples, e.g, when the UL sounding is performed using a precoded RS, the precoder indication provided to the UE may be in the form of index of the preferred SRS beam transmitted by the UE, or indicating a linear combination of multiple beams consisting of {index, weight} pairs, where the weights may contain only angle or angle and magnitude information. The weights may be quantized/compressed using known techniques.

Next, the UE transmits its data symbols using the transmitter beamformers obtained as indicated above. The data symbols are received by the serving APs via their configured receiver beamformers obtained in step 230. These signals are then demodulated as described above for single- or dual-stream transmission.

Details of examples of serving AP selection for a UE are now provided as follows. Examples comprise determining APs to be the first and second APs, indexed I and l′, respectively as referred to above, i.e. which two APs to be serving APs. A simple example is to have the observing APs report channel estimates to the CPU in every coherence block, and then have the CPU loop through all possible combinations of l, l′ (with l, l′ in the AP superset for the UE) via a brute force search, and find the combination that maximizes the rate (R₁+R₂ above). For every candidate pair (l, l′), find the optimal combination of P₁, P₂, a and b according to the procedure described above, and compute R₁+R₂.

Alternatively, in some examples, a simpler algorithm can be used as follows. First, an AP l is selected by assuming that only single-stream transmission will be performed. For every candidate AP (e.g, every AP in the superset for the UE), evaluate the single-stream rate (with optimal beamformers) as indicated above. The AP yielding the largest single stream rate R₁ is chosen. Next, all other APs in the observing set are considered in order to find the second AP, indexed l′, that maximizes the total rate R₁+R₂ obtainable by dual-stream multiplexing. This in turn can be accomplished by computing R₁+R₂ as indicated above for all candidate second APs l′, applying the optimal powers and beamformers found by the method described therein. Then the AP l′ for which R₁+R₂ is maximal is found.

In either of these examples, the mechanism results in an AP pair (l, l′) that should be designated as serving APs. Irrespective of how the combination (l, l′) of APs is determined, the CPU informs APs l and l′ about their role.

In other examples, the selection of APs I and l′ relies on evaluating the expected inner product between the channel vectors of all serving and observing APs. The two APs selected may be the two APs that have the smallest channel inner-product (meaning the channels are close to orthogonal) under the constraint that the path loss of both channels lie below a pre-determined threshold (such that the resulting SNR is sufficient).

In some examples of this disclosure, selection of serving and/or observing APs may be performed according to a predetermined schedule, that can for example be periodic. In some examples, the rate metric is then a time-average that approximates the statistical expectation (long-term average) of the rates. More specifically, for example, the observing APs periodically communicate to the CPU the channel estimates Gₗ^{t} where I is the AP index and t is a time index. When it is time to perform an update, the CPU may examine all possible combinations l, l′ of potential serving APs. For each pair, the CPU first determines a time window length, T, based on similar considerations as discussed above for computation of beamformers based on long-term statistics. Given T, the CPU computes a long-term rate consisting of a time average of R₁+R₂ obtained by inserting the channels {Gₗ^{t-T}, G_{l′}^{t-T}, Gₗ^{t-T+1}, G_{l′}^{t-T+1}, . . . , Gₗ^{t}, G_{l′}^{t}} into the expressions for R₁ and R₂ in Section 6.3 (#2.ii), using the values of P₁, P₂, a and b optimized according to the procedure described therein. The pair (l, l′) of APs that maximize the so-obtained time-average of R₁+R₂ are then designated as new serving APs, and these APs are informed about their roles.

In alternative examples, which may be of lower complexity, the pair l, l′ of serving APs for a UE are determined based on invoking APs with minimal path loss, i.e. largest path gain (large expected norm of the channel estimate Gₗ) and low channel correlation (low expectation for inner product Gₗ^{t H}G_{l′}^{t}). Greedy methods may be used, e.g, choosing the highest path gain AP l and identifying the least correlated second AP l′ whose path gain is above a threshold, or identifying AP with next-best path gain subject to correlation remaining below a threshold.

As indicated above, these examples are given for two APs and two streams from the UE, though these can readily be extended to include three or more APs and three or more streams.

In some examples, it is noted that the UE is informed about P₁, P₂, a and b, but does not need explicit information on which APs are actually decoding its transmitted uplink streams.

Serving AP selection principles provided in this disclosure may be also be applied to DL transmission in some examples. In such examples, UL sounding information (e.g, channel information) may be used by the APs to similarly determine DL transmit precoding. In some examples, the UE may also be informed about recommended reception weights. In some examples, the UE may determine the combining weights autonomously based on e.g. DMRS embedded in the DL data transmission, where the DMRS are precoded and power controlled identically to data transmissions. Again, in some examples, the UE may not be informed about which AP is transmitting the data.

In some examples, the serving AP set and weights for UL and DL transmission towards a given UE may be the same. For example, the network (e.g, node, central processor or CPU, which are used interchangeably herein) may provide UL transmit weights for the UE and determine UL receive weights for the APs. The receive weights, or scaled or otherwise modified weight values, may subsequently be used for DL transmit precoding. Similarly, the UE may use UL transmit weights provided by the network for DL reception, or at least narrow the range of DL combining weight optimization based on the preferred UL precoding knowledge.

In some additional examples, the instantaneous serving subset of APS that are serving a UE may be adapted fast, e.g, per coherence block or coherence time, or faster. In such examples, an intermediate set of APs may be formed, referred to as a contributing AP set. This set is larger than the serving set but smaller than the superset and provides instantaneous channel information (e.g, channel state information, channel estimates etc) to a weight computing node such as an AP or central processor/CPU. Instantaneously, e.g, at coherence time scales, the serving AP subset (e.g, size equal to the number of streams or layers for the UE) to which data and weights are routed for the current scheduling instance may be selected based on instantaneous fading.

This approach may for example reduce data routing and weight distribution load compared to using a larger serving AP set of the same size as the contributing set, while providing performance close to using the larger serving AP set.

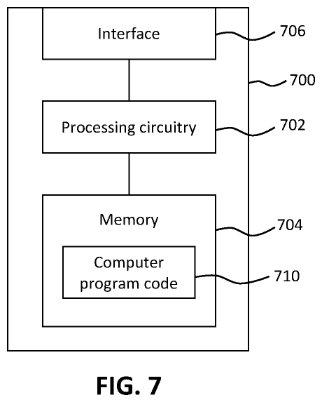

FIG. 7 is a schematic of an example of an apparatus 700 in a node in a network of selecting access points for serving a User Equipment (UE). The apparatus 700 comprises processing circuitry 702 (e.g., one or more processors) and a memory 704 in communication with the processing circuitry 702. The memory 704 contains instructions, such as computer program code 710, executable by the processing circuitry 702. The apparatus 700 also comprises an interface 706 in communication with the processing circuitry 702. Although the interface 706, processing circuitry 702 and memory 704 are shown connected in series, these may alternatively be interconnected in any other way, for example via a bus.

In one embodiment, the memory 704 contains instructions executable by the processing circuitry 702 such that the apparatus 700 is operable/configured to receive, for each access point in a first set of one or more access points, information identifying channel information between the access point and the UE, wherein the first set of access points comprises access points currently serving the UE: receive, for each access point in a second set of one or more access points, information identifying channel information between the access point and the UE, wherein the second set of access points comprise access points not currently serving the UE; and select one or more access points from the first set of one or more access points and/or one or more access points from the second set of one or more access points to serve the UE based on the information identifying the channel information between the UE and the access points in the first and second sets of access points. In some examples, the apparatus 700 is operable/configured to carry out the method 500 described above with reference to FIG. 5.

Examples of the present disclosure also include apparatus in a node in a network of selecting access points for serving a User Equipment (UE). The apparatus comprises a first receiving module configured to receive, for each access point in a first set of one or more access points, information identifying channel information between the access point and the UE, wherein the first set of access points comprises access points currently serving the UE: a second receiving module configured to receive, for each access point in a second set of one or more access points, information identifying channel information between the access point and the UE, wherein the second set of access points comprise access points not currently serving the UE; and a selecting module configured to select one or more access points from the first set of one or more access points and/or one or more access points from the second set of one or more access points to serve the UE based on the information identifying the channel information between the UE and the access points in the first and second sets of access points.

Examples of this disclosure may also provide a communication system including a host computer comprising processing circuitry configured to provide user data, and a communication interface configured to forward the user data to a network for transmission to a user equipment (UE), wherein the network comprises a base station (or access point) having a radio interface and processing circuitry, the base station's processing circuitry configured to perform any of the example methods as disclosed herein performed by an access point. The system may further include the base station. Additionally or alternatively, the system may further include the UE, wherein the UE is configured to communicate with the base station. The processing circuitry of the host computer may be configured to execute a host application, thereby providing the user data, and the UE may comprise processing circuitry configured to execute a client application associated with the host application.

Examples of this disclosure may also provide a method implemented in a communication system including a host computer, a base station (or access point) and a user equipment (UE). The method comprises, at the host computer, providing user data and, at the host computer, initiating a transmission carrying the user data to the UE via a network comprising the base station, wherein the base station may perform any of the example methods as disclosed herein performed by an access point. The method may also comprise, at the base station, transmitting the user data. The user data may be provided at the host computer by executing a host application, the method may further comprise, at the UE, executing a client application associated with the host application.

Examples of this disclosure may also provide a communication system including a host computer comprising processing circuitry configured to provide user data, and a communication interface configured to forward user data to a network for transmission to a user equipment (UE). The UE comprises a radio interface and processing circuitry, the UE's processing circuitry configured to perform any of the example methods as disclosed herein performed by a UE. The system may further include the UE. The network may further include a base station (or access point) configured to communicate with the UE. The processing circuitry of the host computer may be configured to execute a host application, thereby providing the user data, and the UE's processing circuitry may be configured to execute a client application associated with the host application.

Examples of this disclosure may also provide a method implemented in a communication system including a host computer, a base station (or access point) and a user equipment (UE), the method comprising, at the host computer, providing user data and, at the host computer, initiating a transmission carrying the user data to the UE via a network comprising the base station, wherein the UE may perform any of the example methods as disclosed herein performed by a UE. The method may further comprise, at the UE, receiving the user data from the base station.

Examples of this disclosure may also provide a communication system including a host computer comprising a communication interface configured to receive user data originating from a transmission from a user equipment (UE) to a base station (or access point), wherein the UE comprises a radio interface and processing circuitry, the UE's processing circuitry configured to perform any of the example methods as disclosed herein performed by a UE. The system may further include the UE. The system may further include the base station, wherein the base station comprises a radio interface configured to communicate with the UE and a communication interface configured to forward to the host computer the user data carried by a transmission from the UE to the base station. The processing circuitry of the host computer may be configured to execute a host application, and the UE's processing circuitry may be configured to execute a client application associated with the host application, thereby providing the user data. The processing circuitry of the host computer may be configured to execute a host application, thereby providing request data, and the UE's processing circuitry may be configured to execute a client application associated with the host application, thereby providing the user data in response to the request data.

Examples of this disclosure may also provide a method implemented in a communication system including a host computer, a base station (or access point) and a user equipment (UE). The method comprises, at the host computer, receiving user data transmitted to the base station from the UE, wherein the UE may perform any of the example methods as disclosed herein performed by a UE. The method may further comprise, at the UE, providing the user data to the base station. The method may further comprise, at the UE, executing a client application, thereby providing the user data to be transmitted and, at the host computer, executing a host application associated with the client application. The method may further comprise, at the UE, executing a client application and, at the UE, receiving input data to the client application, the input data being provided at the host computer by executing a host application associated with the client application, wherein the user data to be transmitted is provided by the client application in response to the input data.

Examples of this disclosure may also provide a communication system including a host computer comprising a communication interface configured to receive user data originating from a transmission from a user equipment (UE) to a base station (or access point), wherein the base station comprises a radio interface and processing circuitry, the base station's processing circuitry configured to perform any of the example methods as disclosed herein performed by a UE. The system may further include the base station. The system may further include the UE, wherein the UE is configured to communicate with the base station. The processing circuitry of the host computer may be configured to execute a host application, and the UE may be configured to execute a client application associated with the host application, thereby providing the user data to be received by the host computer.

Examples of this disclosure may also provide a method implemented in a communication system including a host computer, a base station (or access point) and a user equipment (UE). The method comprises, at the host computer, receiving, from the base station, user data originating from a transmission which the base station has received from the UE, wherein the UE may perform any of the example methods as disclosed herein performed by a UE. The method may further comprise, at the base station, receiving the user data from the UE. The method may further comprise, at the base station, initiating a transmission of the received user data to the host computer.

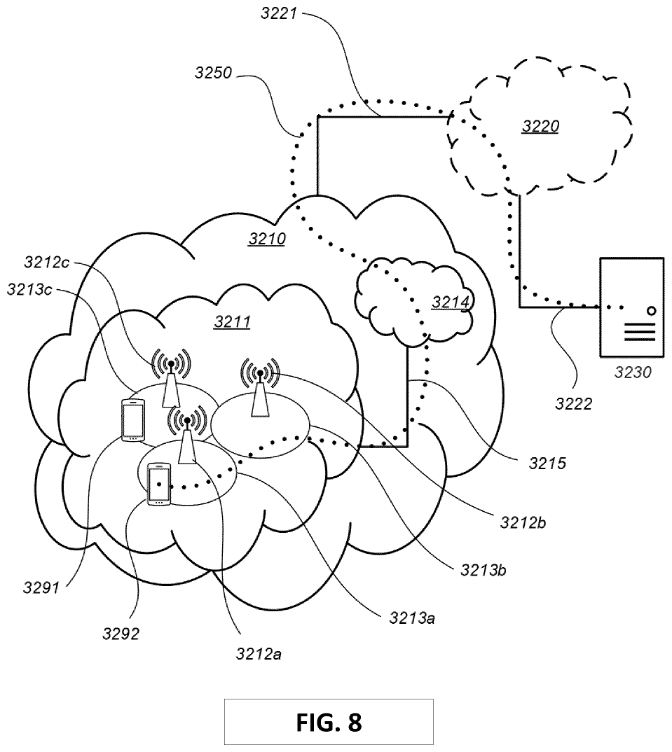

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network: the intermediate network 3220, if any, may be a backbone network or the Internet: in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

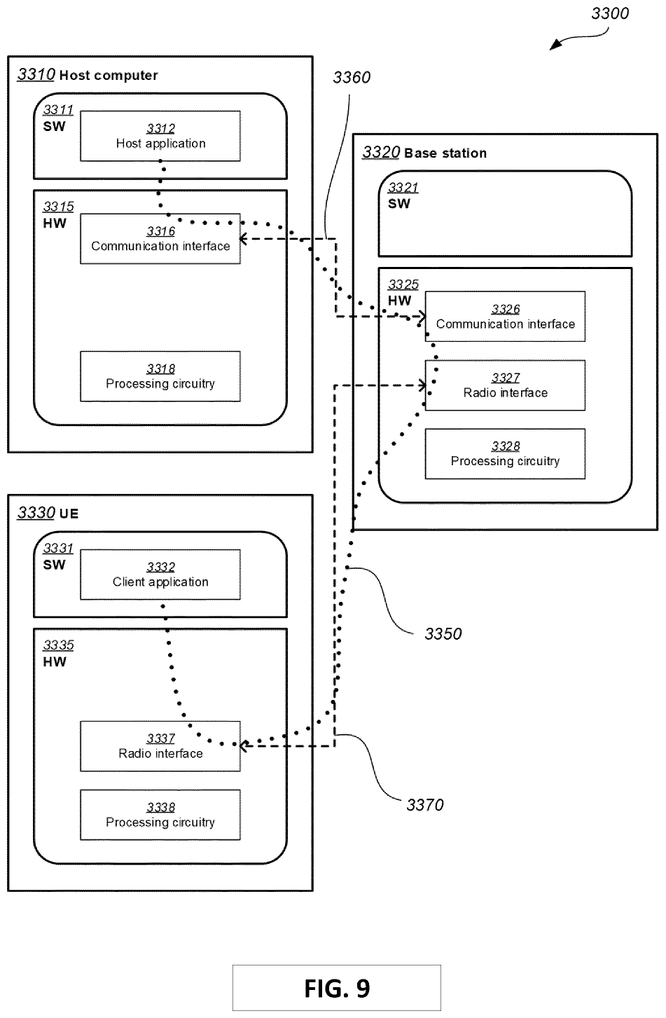

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes: the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.: the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

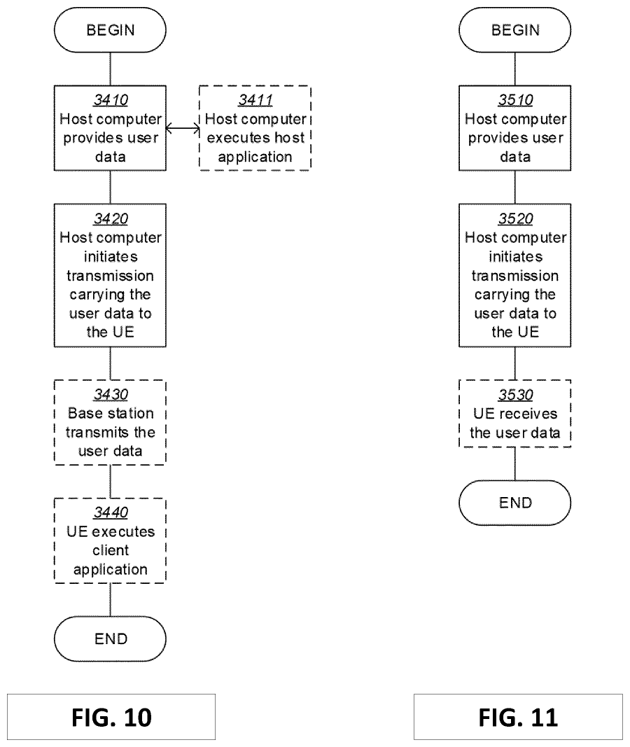

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

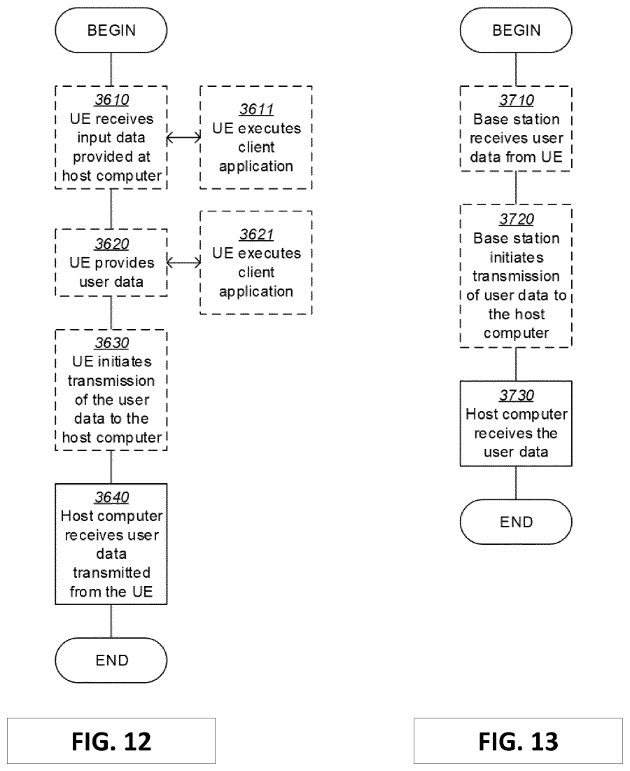

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a node in a network of selecting access points for serving a User Equipment, UE, the method comprising:
receiving, for each access point in a first set of one or more access points, information identifying channel information between the access point and the UE, the first set of access points comprising access points currently serving the UE;
receiving, for each access point in a second set of one or more access points, information identifying channel information between the access point and the UE, the second set of access points comprising access points not currently serving the UE; and
selecting one or both of one or more access points from the first set of one or more access points and one or more access points from the second set of one or more access points to serve the UE based on the information identifying the channel information between the UE and the access points in the first and second sets of access points.

2. The method of claim 1, wherein the information identifying the channel information between each access point of the one or both of the first and the second sets of one or more access points and the UE comprises information identifying respective channel information between each antenna of the access point and each antenna of the UE.

3. The method of claim 1, comprising sending an indication to each of the selected one or more access points that the access point is to serve the UE.

4. The method of claim 1, comprising sending, to each access point that is not selected in the first set of one or more access points, an indication that the access point is to not serve the UE.

5. The method of claim 1, wherein the first and second sets of one or more access points comprise access points whereby, for each access point, a property of a channel between the access point and the UE satisfies a predetermined criterion.

6. The method of claim 1, wherein selecting one or more access points from the first set of one or more access points and/or one or more access points from the second set of one or more access points to serve the UE comprises reselecting the first set of access points based on the information identifying the channel information between the UE and the access points in the first and second sets of access points, and wherein the method comprises repeating the method of selecting access points for serving the UE.

7.-11. (canceled)

12. The method of claim 1, wherein selecting one or both of one or more access points from the first set of one or more access points and one or more access points from the second set of one or more access points to serve the UE comprises selecting up to a predetermined number of access points from the first set of one or more access points so as to maximize a rate of data transmitted between the UE and the selected one or more access points.

13. The method of claim 1, wherein selecting one or more access points from the first set of one or more access points and/or one or more access points from the second set of one or more access points to serve the UE comprises selecting a number of access points from the first and/or second set of access points with highest data rates determined based on the channel information between the access point and the UE, wherein the selected number of access points is greater than or equal to a number of data streams transmitted to and/or from the UE.

14. The method of claim 1, wherein selecting one or both of one or more access points from the first set of one or more access points and one or more access points from the second set of one or more access points to serve the UE comprises selecting a number of access points from the first and/or second set of access points with a smallest inner product of channel vectors, wherein the channel vectors are determined based on the channel information between the access points and the UE, and wherein the selected number of access points is greater than or equal to a number of data streams transmitted to and/or from the UE.

15. The method of claim 1, wherein selecting one or both of one or more access points from the first set of one or more access points and one or more access points from the second set of one or more access points to serve the UE comprises selecting one or more access points with available fronthaul capacity for exchanging user data between the one or more access points and a processing node.

16. The method of claim 1, comprising receiving the information identifying the channel information between the first set of one or more access points and the UE with a periodicity equal to or longer than a coherence time of a channel between the first set of one or more access points and the UE.

17. The method of claim 16, comprising receiving the information identifying the channel information between the second set of one or more access points and the UE with a periodicity longer than the periodicity of receiving the information identifying the channel information between the first set of one or more access points and the UE.

18. The method of claim 1, comprising selecting one or both of one or more access points from the first set of one or more access points and one or more access points from the second set of one or more access points to serve the UE with a periodicity equal to or longer than a periodicity of a coherence block.

19. The method of claim 1, wherein the information identifying the channel information between the UE and each access point in the first set of one or more access points comprises information identifying channel estimates of channels between the UE and each access point in the first set of one or more access points.

20. The method of claim 1, wherein the information identifying the channel information between the UE and each access point in the second set of one or more access points comprises one or more of:
information identifying channel estimates of channels between the UE and each access point in the second set of one or more access points;
information identifying signal strength of a signal between the UE and each access point in the second set of one or more access points; or
information identifying a path loss between the UE and each access point in the second set of one or more access points.

21. The method of claim 1, wherein the information identifying the channel information between the UE and each access point in the first and second sets of one or more access points is based on one or both pilot signals and data signals transmitted by the UE.

22. The method of claim 1, wherein the node in the network comprises a processing unit or access point.

23.-47. (canceled)

48. An apparatus in a node in a network of selecting access points for serving a User Equipment, UE, the apparatus configured to:
receive, for each access point in a first set of one or more access points, information identifying channel information between the access point and the UE, the first set of access points comprising access points currently serving the UE;
receive, for each access point in a second set of one or more access points, information identifying channel information between the access point and the UE, the second set of access points comprising access points not currently serving the UE; and
select one or both of one or more access points from the first set of one or more access points and one or more access points from the second set of one or more access points to serve the UE based on the information identifying the channel information between the UE and the access points in the first and second sets of access points.

49. The apparatus of claim 48, wherein the information identifying the channel information between each access point of the one or both of the first and the second sets of one or more access points and the UE comprises information identifying respective channel information between each antenna of the access point and each antenna of the UE.
